(19) United States
(12) Patent Application Publication
(10) Pub. No.: US 2006/0150077 A1
(43) Pub. Date: Jul. 6, 2006

(54) User interface method

(75) Inventors: Graham A.M. Sheldon, Seattle, WA (US); Tobin J. Zerba, Seattle, WA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: MICROSOFT CORPORATION, Redmond, WA (US)

(21) Appl. No.: 11/026,871

(22) Filed: Dec. 30, 2004

(51) Int. Cl. G06F 17/24; G06F 17/21

(52) U.S. Cl. 715/509

(57) ABSTRACT

In a user interface method, an electronic form is displayed to a user, the electronic form to allow the user to gather information. An event associated with the electronic form is detected. A context is determined based on the detected event. Information relevant to the context is retrieved from a database, and the displayed electronic form is modified to allow the electronic form to display to the user the information relevant to the context.

### BACKGROUND

When a user performs a task using a computer running a software application, it may be helpful to the user to provide the user with information that is relevant to the task. For example, if a customer service representative is filling out a form for scheduling a service for a customer, it would be helpful to the customer service representative to provide the customer service representative with an indication of resources that are qualified to perform the service.

Some forms-based applications employ user interface mechanisms that help in filling out a form. For example, a user may be able to open a window separate from the form that shows and/or allows the user to search for possible entries for a particular field of a form. The user can select one of these possible entries. Upon selection, the window is closed and the selected entry is automatically entered into the form.

### SUMMARY

Example user interface methods are disclosed. In one example, a method includes displaying an electronic form to a user, the electronic form to allow the user to gather information. The method additionally includes detecting an event associated with the electronic form, and determining a context based on the detected event. The method also includes retrieving information relevant to the context from a database, and modifying the displayed electronic form to allow the electronic form to display to the user the information relevant to the context.

In another example, a method includes receiving a request for an electronic form via a network, the electronic form to allow a user to gather information. The method also includes transmitting the electronic form via the network, the electronic form including controls to allow a portion of the electronic form to display information received from a server. The method further includes receiving data indicative of a context via the network, the context associated with the electronic form. The method still further includes retrieving information relevant to the context from a database. The method additionally includes transmitting the information relevant to the context via the network, the information to be displayed in the electronic form.

### DRAWINGS

FIG. 1 is a block diagram of an example system that may be used to implement example methods described herein;

FIG. 2 is a block diagram of an example computing device that may be used to implement a portion of the system of FIG. 1;

FIG. 3 is a flow diagram of an example method for assisting a user in completing an electronic form;

FIG. 4 is an illustration of an example electronic form;

FIG. 5 is an illustration of another example electronic form;

FIG. 6 is another illustration of the example electronic form of FIG. 5;

FIG. 7 is a flow diagram of an example method for assisting a user in completing an electronic form; and

FIG. 8 is a flow diagram of an example method for initially displaying an electronic form.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

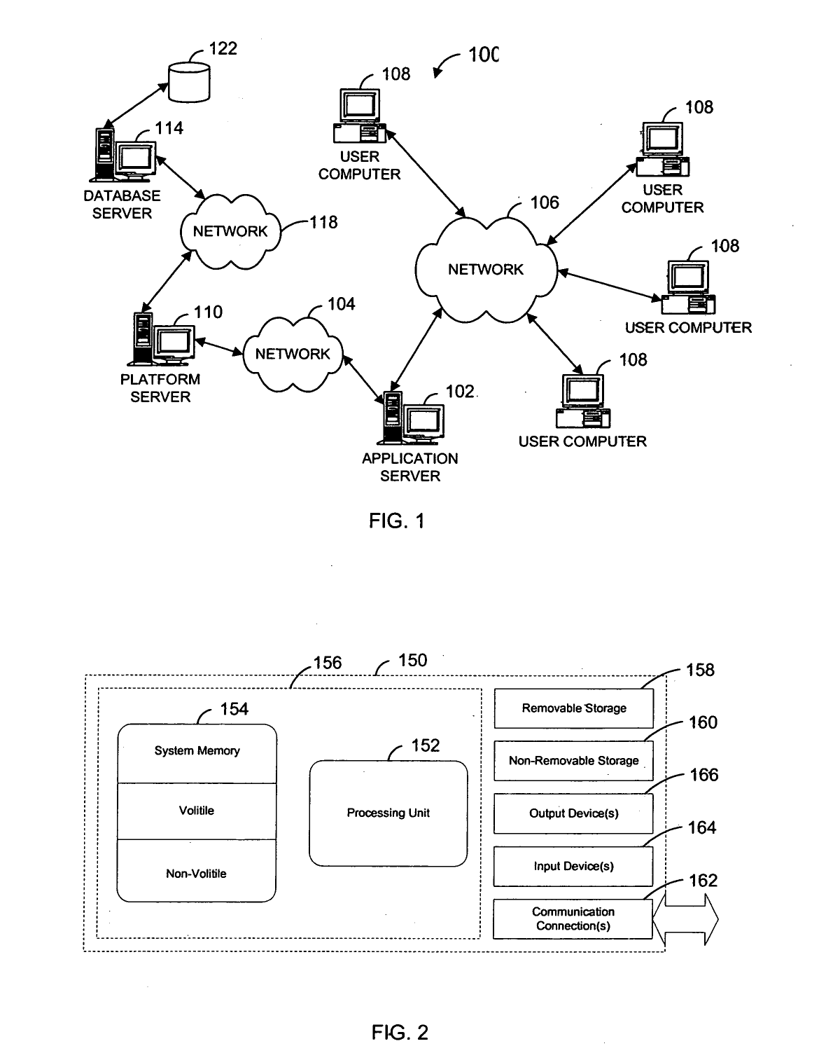

FIG. 1 is a block diagram of an example system 100 that may be used to implement example methods described herein. The example system 100 may be used to implement a system that employs electronic forms. As just one example, the system 100 may be used to implement a customer relationship management (CRM) system. The system 100 includes a server system 102 coupled to a network 104 and a network 106. Also coupled to the network 106 is a plurality of user computers 108. The network 106 allows each of the server system 102 and the user computers 108 to communicate with each other and other computer systems. The network 104 may comprise one or more of a local area network (LAN), an intranet, an extranet, a wide area network (WAN), a hardwired network, a wireless network, etc. The network 106 may comprise one or more of a LAN, an intranet, an extranet, a WAN, a hardwired network, a wireless network, the Internet, etc.

The server system 102 may comprise one or more servers. The server system 102 may store information, receive information via the networks 104 and 106, and disseminate information via the networks 104 and 106. For example, the server system 102 may disseminate information to the user computers 108 via the network 106.

The server system 102 may provide user interfaces to the user computers 108. For example, in one implementation, persons, via the user computers 108 and the network 106, may request from the server system 102 electronic forms related to a CRM system. In response, the server system 102 may disseminate the electronic forms to the user computers 108 via the network 106. In this implementation, the user computers 108 may execute applications which may permit persons to view and interact with the electronic forms. For instance, persons may enter information into the electronic forms using the user computers 108 and such information may be transmitted back to the server system 102 via the network 106. The electronic forms may be stored in the server system 102 and/or in a database, for example.

The server system 102 may also implement logical components of an application such as a CRM application. For example, the server system 102 may implement logical components of a subsystem for scheduling a service requested by a customer. As another example, the server system 102 may implement logical components of CRM subsystem for tracking and/or resolving a customer service issue. For instance, persons may enter information using the user computers 108 and such information may be transmitted back to the server system 102 via the network 106. Then, the information may be used in the application implemented, at least in part, by the server system 102.

Each of the user computers 108 may include, for example, web browsing software for interacting with the server system 102. In these implementations, the web browsing software may permit the user computer 108 to display an electronic form and allow a person to interact with the electronic form. In other implementations, some or all of the user computers 108 may include specialized and/or dedicated software for interacting with the server system 102.

The system 100 may also comprise a server system 110 coupled to the server system 102 via the network 104. The server system 110 may store information, receive information via the network 104, and disseminate information via the network 104. For example, the server system 110 may receive and/or transmit information to the server system 102.

The system 100 may also comprise a server system 114 coupled to the server system 110 via a network 118. The server system 114 may also be coupled to a database 122. The server system 114 may receive information via the network 118, and disseminate information via the network 118. Similarly, the server system 118 may retrieve information from and/or store information to the database 122. For example, the server system 114 may retrieve information from the database 122 and transmit it to the server system 110 via the network 118.

The server system 110 may act as a platform server that formats data retrieved from the database 122 so it can be used in an application such as a CRM system. For example, in one implementation, the server system 110 may aggregate data retrieved from the database 122 into objects that can be used by a CRM system, for example. For instance, the database server 114 may retrieve data from the database 122, and then transmit the data to the sever system 110 via the network 118. Then, the server system 110 may aggregate the retrieved data into objects that can be used by an application implemented, at least in part, by the server system 102. The server system 110 may be implemented in a manner similar to the manner discussed above with reference to the server system 102.

The server system 114 may interface the server system 110 with the database 122 used in an application such as a CRM system. For instance, persons may enter information using the user computers 108 and such information may be transmitted back to the server system 102 via the network 106. Then, the server system 102 may transmit this information to server system 110. The server system 110 may in turn transmit the information to the server system 114 for storage in the database 122. Similarly, the server system 114 may transmit information from the database 122 to the server system 110. Then, the server system 110 may transmit this information to the server system 102. Next, the server system 102 may transmit this information to a user computer 108 for display in an electronic form. The server system 114 may be implemented in a manner similar to the manner discussed above with reference to the server system 102.

The database 122 may comprise one or more different databases. These databases can be located in one central repository, or alternatively, they can be dispersed among various distinct physical locations. These databases can be categorized and structured in various ways based on the needs and criteria of a particular implementation. A number of techniques can be used to create and organize databases, including techniques known to those of ordinary skill in the art. For example, relational database techniques can be used to logically connect multiple databases.

The database 122 can be physically located separate from the server system 114. The database 122 can be coupled to the server system 114 via a separate, remote server or servers (not shown) and via a network such as the network 118 or some other network (including networks not shown in FIG. 1). Alternatively, the database 122 may be located proximate to one or more servers of the server system 114. Further, one or more servers of the server system 114 may comprise the database 122.

The database 122 may comprise, for example, one or more relational databases, distributed databases, object-oriented databases, mixed object-oriented databases, etc. Database products which may be employed in the example system 100 include, for example, database products available from Microsoft®, IBM, Oracle, Sybase, Computer Associates, etc.

Each of the user computers 108 may comprise, for example, a desktop computer, a laptop computer, a workstation, a server, a mainframe, a minicomputer, a multiprocessor system, a distributed computing system, a personal digital assistant (PDA), a cellular phone, a two-way pager, a programmable consumer electronics device, a network personal computer (PC), or any other device capable of accessing information via the network 106. Each user computer 108 may be linked with the network 106 via a communication link, which may comprise, for example, one or more of a hardwired link, a wireless link, a traditional telephone line, an ISDN line, a DSL link, a T1 line, a T3 line, a cable television line, a cellular link, a two-way pager link, a microwave link, a satellite link, etc. In another implementation, one or more of the user computers 108 may be linked directly to the server system 102 via a direct communications link.

The concepts of “client” and “server,” as used in this application and the industry, are very loosely defined and, in fact, are not fixed with respect to machines or software processes executing on the machines. Typically, a server is a machine (e.g., 102) or process that is providing information to another machine or process, i.e., the “client,” (e.g., 108) that requests the information. In this respect, a computer or process can be acting as a client at one point in time (because it is requesting information) and can be acting as a server at another point in time (because it is providing information). Some computers are consistently referred to as “servers” because they usually act as a repository for a large amount of information that is often requested. For example, a web site is often hosted by a server computer with a large storage capacity, a high-speed processor or processors and a network link having the ability to handle many high-bandwidth communication links.

It is to be understood that the system 100 of FIG. 1 is only one example of a system that may be used to implement example methods described herein. In another system, one or both of the network 104 and the network 118 may be omitted, and the server system 110 and the server system 114 may be coupled to the server system 102 via the network 106, for example. Similarly, the network 104 and the network 118 may be combined. Also, one or more of the server system 102, the server system 110, and the server system 114 may be omitted or combined. One of ordinary skill in the art will recognize many other modifications, variations, etc.

FIG. 2 is a block diagram of an example computing device, 150 that may be used to implement the server system 102 of FIG. 1. For example, the server system 102 may comprise one or more devices such as the computing device 150. Similarly, a device such as the device 150 may be used to implement one or more of the user computers 108, the server system 110, and the server system 114.

In its most basic configuration, computing device 150 typically includes at least one processing unit 152 and memory 154. Depending on the exact configuration and type of computing device, memory 154 may be volatile (such as random access memory (RAM)), non-volatile (such as read only memory (ROM), flash memory, etc.) or some combination of the two. This most basic configuration is illustrated in FIG. 2 by dashed line 156. Additionally, device 150 may also have additional features/functionality. For example, device 150 may also include additional storage (removable and/or non-removable) including, but not limited to, magnetic or optical disks or tape. Such additional storage is illustrated in FIG. 2 by removable storage 158 and non-removable storage 160. Computer storage media includes volatile and nonvolatile, removable and non-removable media implemented in any method or technology for storage of information such as computer readable instructions, data structures, program modules or other data. Memory 154, removable storage 158 and non-removable storage 160 are all examples of computer storage media. Computer storage media includes, but is not limited to, RAM, ROM, erasable programmable ROM (EPROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium which can be used to store the desired information and which can accessed by device 150. Any such computer storage media may be part of device 150.

Device 150 may also contain communications connection(s) 162 that allow the device to communicate with other devices. For example, the communication connection 162 may couple the device 150 to a network such as the network 106 of FIG. 1 and/or a database system such as the database 122. Communications connection(s) 162 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer readable media as used herein includes both storage media and communication media.

Device 150 may also have input device(s) 164 such as keyboard, mouse, pen, voice input device, touch input device, etc. Output device(s) 166 such as a display, speakers, printer, etc. may also be included. All these devices are well known to those of ordinary skill in the art and therefore are not discussed at length here.

It is to be understood that the device 150 of FIG. 2 is merely one example of a device that may be used to implement elements of FIG. 1 such as the server system 102 and the user computer 108. Other devices may used alternatively or additionally. Examples of other devices that may be utilized were described above with reference to FIG. 1.

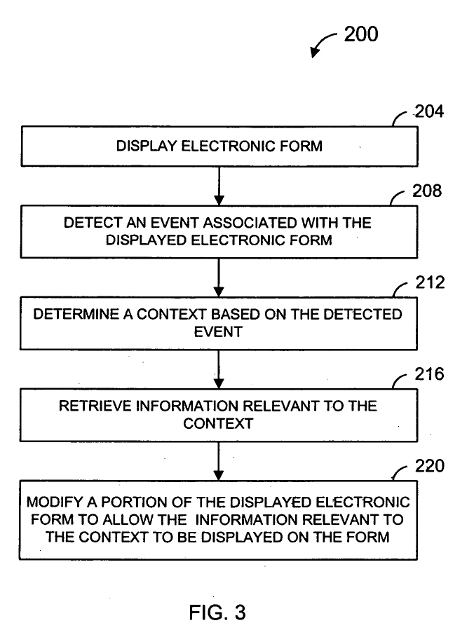

FIG. 3 is a flow diagram of an example method 200 for assisting a user in completing an electronic form. The example method 200 may be implemented by a system such as the system 100 of FIG. 1, and will be explained with reference to FIG. 1.

At a block 204, an electronic form is displayed. For example, an electronic form may be displayed on a display of a user computer 108. The electronic form may be provided to the user computer 108 by the server system 102, via the network 106. In one implementation, the electronic form may comprise a web page form. The web page form may be generated using a variety of techniques, including techniques known to those of ordinary skill in the art. For example, the web page form may be generated using Web Form technology available from Microsoft®. The web page form may be transmitted to the user computer 108. A web browser application executed by the user computer 108 may then display the web page form on the display of the user computer 108. If the user computer 108 is a device such as the device 150 of FIG. 2, the web browser application can be stored in the memory 154 and executed by the processor unit 152.

At a block 208, an event associated with the displayed electronic form is detected. The event may comprise, for example, a user activity associated with the electronic form. Examples of user activities associated with the displayed electronic form include events such as when a user gives a form element a focus (e.g., the user clicks on a box on the form using a mouse, the user uses a TAB key or an arrow key of a keyboard to move a cursor to a box on the form, etc.) (often referred to by those of ordinary skill in the art as an “OnFocus” event), when a form element loses focus (e.g., the user clicks on or uses a TAB/arrow key to move a cursor to a different box on the form, etc.) (often referred to by those of ordinary skill in the art as an “OnBlur” event), the user alters data in a form element (often referred to by those of ordinary skill in the art as an “OnChange” event), the user clicks on a form element (often referred to by those of ordinary skill in the art as an “OnClick” event), the user passes a mouse cursor over a form element (often referred to by those of ordinary skill in the art as an “OnMouseOver” event), etc. A form element may comprise an element of an electronic form such as a box for entering alphanumeric text, a checkbox, a button, etc. Another example of a user activity is a user changing a value of a field on a form.

Controls associated with the electronic form may be used to detect a user activity such as those described above. Such controls may be implemented using a variety of techniques, including known techniques. For example, technologies for implementing forms with controls (either client-side or server-side controls) Active Server Page (ASP) technology available from Microsoft®, common gateway interface (CGI) technology, Fast CGI, Java Server Page technology, hyper text markup language (HTML) controls, ActiveX controls, Web Form controls available from Microsoft®, java controls, etc. For instance, if a user employs a web browser executed by the user computer 108, for example, to perform an activity, such as using a mouse to click on a portion of a web page form, controls associated with the web page form and implemented by the user computer 108 may detect this activity.

Other examples of events associated with the form include a timer expiration indicating a lack of user action (e.g., a lack of keyboard strokes, a lack of mouse movement, a lack of cursor movement, etc.), receipt of a message indicating that a change associated with the form has occurred (e.g., a previous selection is no longer available), etc.

At a block 212, a context may be determined based on the event detected at the block 208. The context may correspond to, for example, a current form-related activity of the user. For instance, if the user has placed a cursor in a box on the electronic form used for entering a starting time of a service to be provided to a customer, the context may indicate that a customer service representative is attempting to schedule a service for the customer. The context optionally may be determined further based on data previously entered into the electronic form by the user. For instance, if the user has placed a cursor in a box on the electronic form used for entering a starting time of a service to be provided to a customer, and the user has already entered data specifying a service to be performed, the context may indicate that a customer service representative is attempting to schedule the specified service for the customer.

In one implementation, the server system 102 may determine the context. For example, the user computer 108 may transmit to the server system 102 an indication of the activity detected at the block 208. The server system 102 may then use this information to determine the context. Optionally, the server system 102 may also use data previously entered into the electronic form to determine the context. In other implementations, the server system 102 may determine the context, at least in part, based on data received from the server system 110 and/or the sever system 114. Generally, the context may be determined by one or more of the server system 102, the server system 110, the server system 114, and one or more of the user computers 108.

At a block 216, information relevant to the context may be retrieved. Such information may be retrieved from a file, from a database, from another computer system such as a server system, etc. For instance, if it is determined that the user has placed a cursor in a box on the electronic form used for entering a starting time of a service, relevant information such as a preferred range of times could be retrieved. Optionally, information already entered into the electronic form by the user may be used to retrieve relevant information. For instance, if the user has placed a cursor in a box on the electronic form used for entering a starting time of a service, and the user has already entered data identifying the customer, relevant information such as a range of times preferred by the identified customer could be retrieved. Depending on the context determined at the block 212, different information may be retrieved at the block 216. Similarly, depending on data already entered into the form by the user, different information may be retrieved at the block 216.

Referring to FIG. 1, the server system 102 may retrieve information relevant to the context. For example, the server system 102 may retrieve the information from one or more files stored at the server system 102, from another server system such as the server system 110 and/or the server system 114. As a more particular example, the server system 102 could issue a request for the information to the server system 110. In response, the server system 110 could issue a request to the server system 114. In response, the server system 114 could retrieve the information from the database 122 and transmit the information back to the server system 110. Then, the server system 110 could transmit the information to the server system 102. It is to be understood that the information may be retrieved from multiple sources. For instance, some of the information may be retrieved from a file stored at the server system 102 and some of the information may be retrieved from the database 122 via the server system 110 and the server system 114.

At a block 220, a portion of the displayed electronic form may be modified to allow the information retrieved at the block 216 to be displayed on the electronic form. For example, the displayed electronic form may be modified to display some or all of the information retrieved at the block 216. Additionally, the displayed electronic form may be modified to provide mechanisms such as buttons, tabs, pull-down menus, drop-down menus, etc., to allow a user to display on the electronic form some or all of the information retrieved at the block 216. Referring to FIG. 1, the server system 102 may cause the electronic form displayed on the user computer 108 to be modified to allow the information retrieved at the block 216 to be displayed on the electronic form. In implementations in which the electronic form is a web page form, the server system 102 may modify the web page form using a technology such as ASP technology available from Microsoft®, CGI technology, Fast CGI, Java Server Page technology, HTML controls, ActiveX controls, Web Form controls available from Microsoft®, java controls, etc.

Although particular blocks of the example method 200 were described above as being implemented by particular elements of the system 100 of FIG. 1, it will be understood by those of ordinary skill in the art that each block may implemented, at least in part, by different elements of the system 100 as well. For example, although the block 212 was described as being implemented by the server system 102, in other implementations the block 212 may be implemented, at least in part, by the user computer 108.

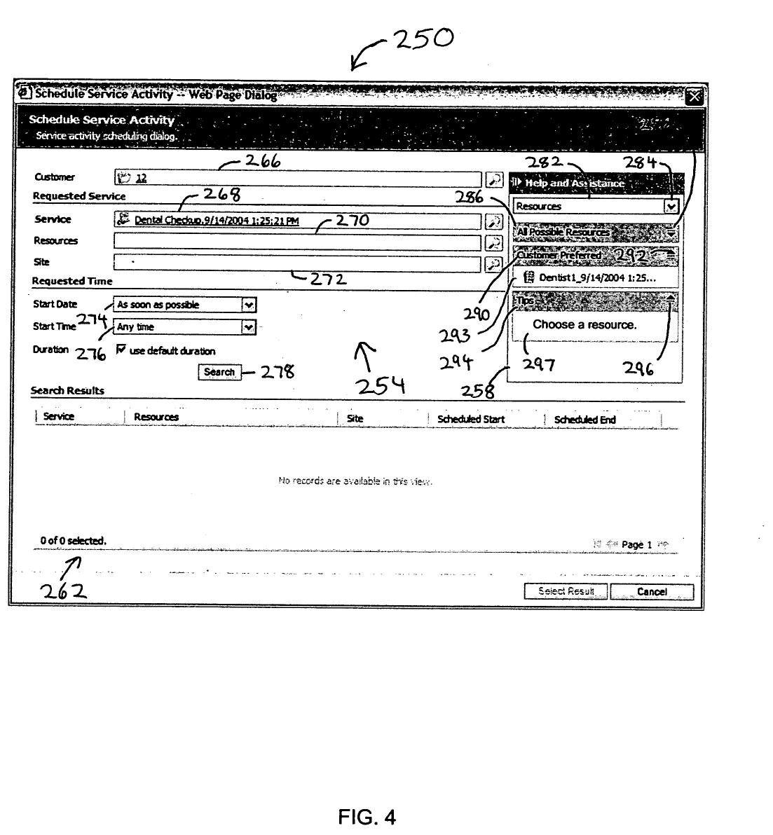

FIG. 4 is an illustration of an example electronic form 250 that may be used in conjunction with a method such as the method 200 of FIG. 3. The electronic form 250 may be used as part of a CRM system, for example, to assist a user in scheduling a service desired by a customer. The form 250 may be a web page form, for example, and may be displayed on a user computer 108 using a web browser. If the form is a web page form, the form 250 may be generated using a technology such as Active Server Page (ASP) technology available from Microsoft®, common gateway interface (CGI) technology, Fast CGI, Java Server Page technology, hyper text markup language (HTML) controls, ActiveX controls, Web Form controls available from Microsoft®, java controls, etc. Additionally or alternatively, the form 250 may be generated using, for example, one or more of HTML, dynamic HTML, ActiveX, java, C, C#, C++, visual basic, etc.

The form 250 includes a data entry portion 254, an informational portion 258, and a search results portion 262. The data entry portion 254 enables a user to enter data into the form 250 to be used in searching for available times, resources, sites, etc. The informational portion 258 displays data to the user that may be helpful to the user in entering data into the form, for example. The search results portion 262 displays the results of searches the user initiates using the form 250.

The data entry portion 254 includes a box 266 for entering an indication of a customer. The data entry portion 254 also includes a box 268 for entering an indication of the service and a box 270 for entering an indication of a resource to perform the service. The data entry portion 254 also includes a box 272 for entering a site at which the service is to be performed. The data entry portion 254 additionally includes a box 274 for entering an indication of a start date and a box 276 for entering an indication of a start time.

After the user has entered data into some or all of the boxes in the data entry portion 254, the user may select the button 278 to initiate a search. The results of the search may be displayed in the search results portion 262. For example the user may enter an indication of a customer in the box 266, an indication of a desired service in the box 270, and an indication of a desired start date in the box 274. After the user selects the box 278, results of a search that conform to the desired service and the desired start date may be displayed in the results portion 262.

The form 250 may have a plurality of contexts associated with it. One context may be a “Resources” context, for example, associated with the user activity related to the box 270. Referring to FIG. 1, if at the block 208 the user places a cursor in the box 270, for example, the context may be determined at the block 212 as the “Resources” context.

The informational portion 258 may be used to display to the user data relevant to the determined context. The informational portion 258 includes a box 282 that may display an indication of a current determined context. Also, the informational portion 258 may include a mechanism 284 (e.g., a drop-down menu or list) to allow a user to see other contexts associated with the form 250 and/or to switch between contexts. For example, the mechanism may simply show other possible contexts. As another example, the user may be able to select a different context, a “Site” context for example, using the mechanism 284. In response, the informational portion 258 may be changed to display data relevant to the “Site” context and, optionally, a cursor may be moved to the box 272.

The retrieved information relevant to the context (box 216 of FIG. 3) may comprise one or more categories of information. With the example form 250, the context “Resources” includes three categories: “All Possible Resources”, “Customer Preferred”, and “Tips”. The “All Possible Resources” category may, for example, include information related to resources that are capable of performing the desired service. For example, if a desired service has been specified in the box 268, the information in the “All Possible Resources” category may, for example, include information that indicates what resources can perform this service.

The “Customer Preferred” category may, for example, include information related to resources that the customer prefers. This information may be based on, for example, a list of preferences provided by the customer, prior selections of resources by the customer, etc. For example, if a desired service has been specified in the box 268, the information in the “Customer Preferred” category may, for example, include information that indicates what resources the customer prefers to perform this service.

The “Tips” category may, for example, include information related to tips to help the user enter data into this form. For example, the “Tips” category may include, for example, instructions on how to correctly-enter data into the box 270.

The informational portion 258 may include indications of one or more categories associated with the current context. For example, a box 286 may include an indication of the “All Possible Resources” category. Also, a mechanism 288 may be provided to allow a user to view and/or hide information in the “All Possible Resources” category. Similarly, a box 290 may include an indication of the “Customer Preferred” category. A mechanism 292 may be provided to allow a user to view and/or hide information in the “Customer Preferred” category. In the example form 250, the informational portion 258 includes an indication 293 of information in the “Customer Preferred” category. Further, a box 294 may include an indication of the “Tips” category. A mechanism 296 may be provided to allow a user to view and/or hide information in the “Tips” category. In the example form 250, the informational portion 258 includes an indication 297 of information in the “Tips” category.

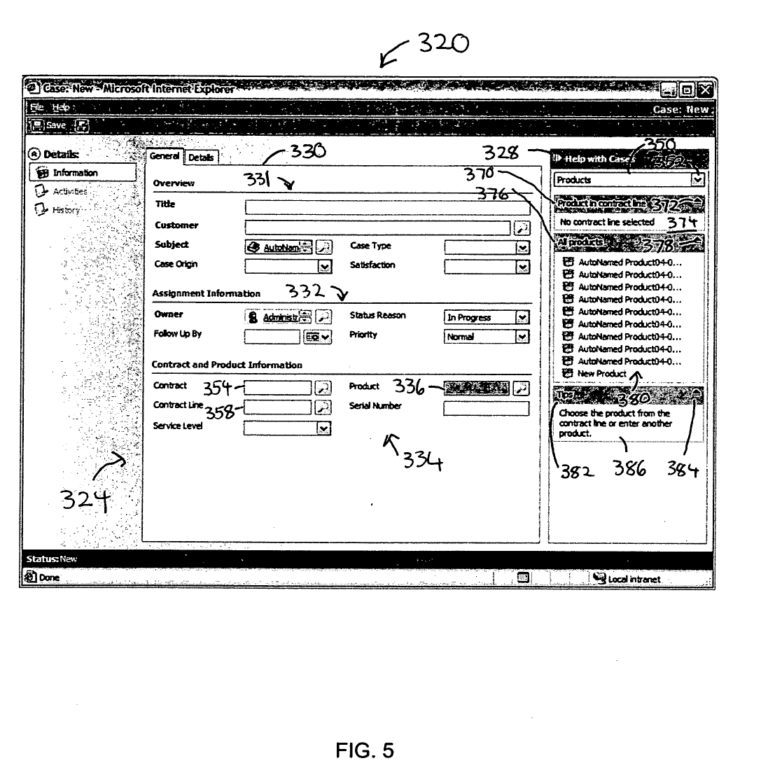

FIG. 5 is an illustration of another example electronic form 320 that may be used in conjunction with a method such as the method 200 of FIG. 3. The electronic form 320 may be used as part of a CRM system, for example, to assist a user in tracking and/or resolving a customer service issue. The form 320 may be a web page form, for example, and may be displayed on a user computer 108 using a web browser. If the form 320 is a web page form, the form 320 may be generated using a technology such as Active Server Page (ASP) technology available from Microsoft®, common gateway interface (CGI) technology, Fast CGI, Java Server Page technology, hyper text markup language (HTML) controls, ActiveX controls, Web Form controls available from Microsoft®, java controls, etc. Additionally or alternatively, the form 320 may be generated using, for example, one or more of HTML, dynamic HTML, ActiveX, java, C, C#, C++, visual basic, etc.

The form 320 includes a data entry portion 324 and an informational portion 328. The data entry portion 324 enables a user to enter data into the form. The informational portion 328 displays data to the user that may be helpful to the user in entering data into the form.

The data entry portion 324 includes a “General” portion 330. The “General” portion 330 includes a portion 331 for entering data associated with an overview of the customer service issue. For example the portion 331 includes boxes for entering a title by which the issue will be referred, an indication of a customer experiencing the issue, a subject of the issue, etc. The “General” portion 330 also includes a portion 332 for entering data associated with assignment of the issue to a particular person, group, etc., for resolving the issue. For example, the portion 332 includes boxes for entering an “owner” of the issue, a date by which the issue should be followed up with the customer, a priority to be assigned to the issue, etc.

Further, the “General” portion 330 also includes a portion 334 for entering data associated with the product that is involved in the issue. For example, the portion 334 includes a box 336 for entering an indication of the product that is involved with the issue.

The form 320 may have a plurality of contexts associated with it. One context may be a “Products” context, for example, associated with the user attempting to enter data into the box 336. Referring to FIG. 3, if at the block 208 the user places a cursor in the box 336, for example, the context may be determined at the block 212 as the “Products” context.

The informational portion 328 may be used to display to the user data relevant to the determined context. The informational portion 328 includes a box 350 that may display an indication of a current determined context. Also, the informational portion 328 may include a mechanism 352 (e.g., a drop-down menu) to allow a user to see other contexts associated with the form 320 and/or to switch between contexts. For example, the mechanism may simply show other possible contexts. As another example, the user may select a different context, a “Contract” context for example, using the mechanism 352 and the informational portion 328 may be changed to display data relevant to the “Contract” context and, optionally, a cursor may be moved to a box 354.

The retrieved information relevant to the context (box 216 of FIG. 3) may comprise one or more categories of information. With the example form 320, the context “Products” includes three categories: “Products in contract line”, “All Products”, and “Tips”. The “Products in contract line” category may, for example, include information related to products that are included in a particular contract line. For example, if a contract line has been specified in a box 358, the information in the “Products in contract line” category may, for example, include information that indicates what products are in this product line

The “All products” category may, for example, include information related to all products being supported. The “Tips” category may, for example, include information related to tips to help the user enter data into this form. For example, the “Tips” category may include, for example, instructions on how to correctly enter data into the box 336.

The informational portion 328 may include indications of one or more categories associated with the current context. For example, a box 370 may include an indication of the “Products in contract line” category. Also, a mechanism 372 may be provided to allow a user to view and/or hide information in the “Products in contract line” category. In the example form 320, the informational portion 328 includes an indication 374 that “Products in contract line” category does not include information because a contract line has not been specified in the box 358.

Similarly, a box 376 may include an indication of the “All products” category. A mechanism 378 may be provided to allow a user to view and/or hide information in the “All products” category. In the example form 320, the informational portion 328 includes indicators 380 of information in the “All products” category.

Further, a box 382 may include an indication of the “Tips” category. A mechanism 384 may be provided to allow a user to view and/or hide information in the “Tips” category. In the example form 320, the informational portion 328 includes an indication 386 of information in the “Tips” category.

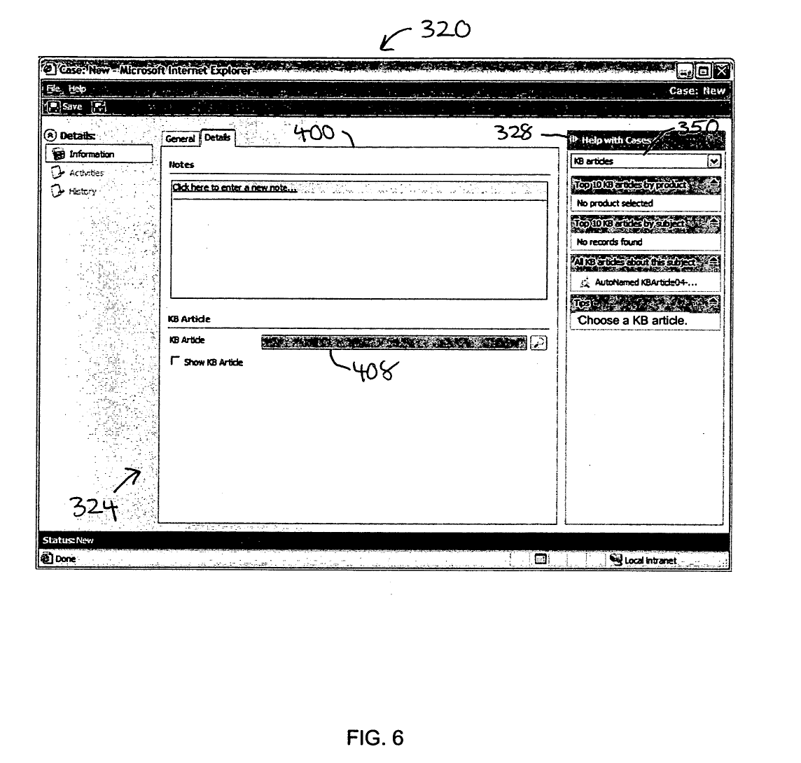

FIG. 6 is another illustration of the example electronic form 320. In FIG. 6, a “Details” portion 400 of the form 320 may permit a user to record notes and to specify a knowledge base (KB) article associated with the issue. For example, the “Details” portion 400 includes a box 408 for indicating a KB article associated with the issue.

In the illustration of FIG. 6, the box 350 displays an indication of the current context “KB articles”. With the example form 320, the context “KB articles” includes four categories: “Top 10 KB articles by product”, “Top 10 KB articles by subject”, “All KB about this subject”, and “Tips”.

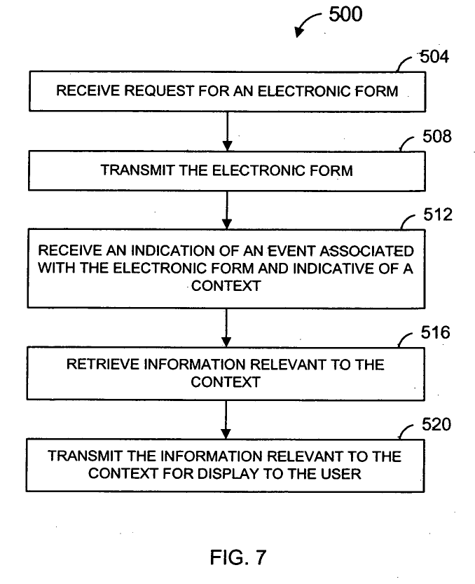

FIG. 7 is a flow diagram of an example method 500 for assisting a user in completing an electronic form. The example method 500 may be implemented by a system such as the system 100 of FIG. 1, and in particular, the method 500 may be implemented by a server system such as one or more of the server system 102, the server system 110, and the server system 114. The method 500 will be explained with reference to FIG. 1.

At a block 504, a request for an electronic form is received. For example, request for an electronic form may be sent by a user computer 108, and the request may be received by the server system 102 via the network 106. At a block 508, the electronic form may be transmitted. For example, the server system 102 may transmit the electronic form to the requesting user computer 108 via the network 106.

At a block 512, an indication of a context associated with the form may be, received. The context may be based on an event associated with the form. For example, a user on the user computer 108 may, for example, place a cursor in a particular portion of the electronic form. This action may be indicative of a context associated with the form. An indication of the context may be transmitted by the user computer 108 and received by the server system 102. For example, the indication may comprise an indication that the user moved the cursor to the particular portion of the form. The server system 102, may also recognize this event as indicative of a context associated with the form. Also, the user computer 108 could detect an event and then determine a context associated with the event. Then, the user computer 108 could then transmit an indication of the context. The indication of the context may also be indicative of the event detected by the user computer 108. Further, the server system 102 may receive the indication of the context from some other computing system such as the server system 110 or the server system 114. Moreover, an application, routine, etc., running on the server system 102 may receive the indication from some other application, routine, etc., running on the server system 102.

At a block 516, information relevant to the context may be retrieved from, for example, one or more files, one or more computer systems, and/or a database, etc. For example, the server system 102 may retrieve relevant information from one or more of a file stored at the server system 102, a file stored at the server system 110, the database 104, etc. Alternatively, the server system 102 may send a request to the server system 110 and/or the server system 114 for information relevant to the context. Thus any combination of the server system 102, the server system 110, and the server system 114, for example, may implement the block 516, at least in part.

Retrieving information relevant to a context may be performed using a variety of techniques. For example, a set of rules may be developed for retrieving information that is relevant to a context. If information relevant to a context is organized into categories, as discussed with respect to FIGS. 4-6, a set of rules may be used for each category. Referring to FIG. 4, a set of rules, for example, may indicate how information in the “Customer Preferred” category is to be retrieved. For instance, the set of rules may indicate that information in this category is to include only resources capable of performing the service specified in the box 268. As another example, a filter may be used to retrieve information relevant to a context. As yet another example, a resource specification that defines what resources are qualified to perform various services may be used. Further, a combination of techniques may be used including for example, two or more of rules, filters, resource specifications, etc.

At a block 520, the relevant information retrieved at the block 516 is transmitted. For example, the server system 102 may transmit the relevant information to the user computer 108 via the network 106.

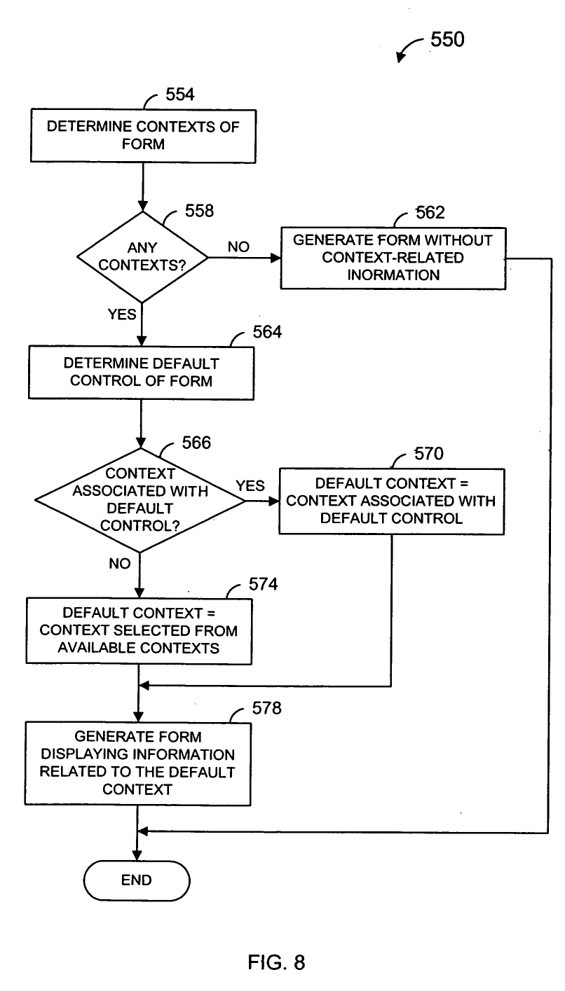

FIG. 8 is a flow diagram of an example method 550 for initially displaying an electronic form. The method 550 may be implemented by a system such as the system 100 of FIG. 1, and in particular, the method 550 may be implemented by one or more server systems such as the server system 102, the server system 110, and/or the server system 114. The method 550 will be explained with reference to FIG. 1.

At a block 554, possible contexts of the form may be determined. Any number of techniques may be used to determine possible contexts of a form. For example, the server system 102 may determine possible contexts of the form based on data associated with the form that specifies the possible contexts.

At a block 558, it may be determined whether the form has any contexts associated with it. For example, the server system 102 may determine whether any contexts are associated with the form based on whether any contexts were determined at the block 554. Also, the server system 102 may determine whether any contexts are associated with the form based on data associated with the form. If there are no contexts associated with the form, the flow may proceed to a block 562. At the block 562, the electronic form may be generated where the electronic form does not include any context-related information. Referring to FIG. 4, for example, an electronic form similar to the example form 250 may be generated, but without the informational portion 258. Then, the flow may end.

If, however, it is determined at the block 558 that there are contexts associated with the form, the flow may proceed to a block 564. At the block 564, a default control of the form maybe determined. For example, the server system 102 may determine the default control of the form based on data associated with the form that specifies the default control. Referring to the example form 250 of FIG. 4, it may be determined that a default control of the form includes placing a cursor in the box 266.

At a block 566, it may be determined if there is a context associated with the default control determined at the block 554. For example, the server system 102 may determine if there is a context associated with the default control. Referring to the example form 250 of FIG. 4, it may be determined whether, if the default control of the form includes placing a cursor in the box 266, there is a context associated with the cursor placed in the box 266. If there is a context associated with the default control, the default context may be determined as this context at a block 570.

If, however, it is determined that there is no context associated with the default control determined at the block 554, the flow may proceed to a block 574. At the block 574, a default context may be selected from one or more contexts associated with the form. For example, the server system 102 may select the context. The context may be selected based on data associated with the form. Such data may specify, for example, a default context associated with the form. As another example, the contexts of the form may be assigned priorities or rankings, and the default context may be selected based on the priorities or rankings.

The flow may proceed from blocks 570 and 574 to a block 587. At the block 578, a form may be generated that displays information relevant to the default context. The block 578 may comprise retrieving the relevant information. The server system 102, for example, may generate the electronic form. Referring to the example form 250 of FIG. 4, if the default context the “Resources” context, the form 250 may be generated with the informational portion 258 displaying information related to the “Resources” context.

Forms similar to the forms 250 and 320 of FIGS. 4-6, as well as methods similar to the methods 200, 500, and 550 of FIGS. 3, 7, and 8 can be used in a variety of contexts. As just a few examples, similar forms and methods could be used in the context of scheduling automobile repairs, appointments with health care professionals, facilitating retail purchases, facilitating placing purchase orders, etc.

Although the forms 250 and 320 are associated with scheduling services and tracking/resolving customer service issues, other types of forms may be utilized as well. For example, CRM forms such as forms associated with recording information related to accounts, forms associated with recording information related to contacts, forms for specifying tasks, forms for sending facsimiles, forms for making phone calls, forms for sending an E-mails, forms for sending letters, forms for making appointments, forms associated with advertising campaigns, forms associated with sales, forms associated with tracking potential sales or any other type of revenue generating opportunities, forms associated with sales of products, forms associated with sales quotes, forms associated with orders, forms associated with invoices, forms associated with providing services, forms associated with service contracts, forms associated with contract lines, etc. Additionally, form other than CRM forms may be utilized. Generally, any form may be utilized in which displaying context-related information to a user may assist the user in entering information into the form or interpreting the form.

Although above-described examples were in the context of CRM systems, other systems may be utilized as well. For example, other “line-of-business” applications may be utilized such as human resource applications, accounting applications, supply chain management applications, resource planning applications, etc. Generally, a line-of-business application is a software application used in running an enterprise such as a business. Similarly, other “front-office applications” may be utilized such, epresentment applications, payment applications, customer self-service applications, etc. Generally, a front-office application is a software application that is associated with interaction of an enterprise (e.g., a business) with its clients (e.g., customers). Additionally, “back-office applications” may be utilized such as human resource applications, accounting applications, supply chain management applications, resource planning applications, etc. Generally, a back-office application is a computer application associated with a process of an enterprise (e.g., a business) and that does not involve interaction with clients (e.g., customers) of the enterprise.

The example methods 200, 500, and 550 of FIGS. 3, 7, and 8 and the example forms 250 and 320 of FIGS. 4-6 may be implemented using various techniques, including techniques known to those of ordinary skill in the art. In one implementation, the user computers 108 each include a web browser application, and the server system 102 is configured to implement the methods and generate the forms described above in conjunction with the web browser application. In other implementations, one or more other applications, including custom applications, may be utilized instead of, or in addition to the web browser.

The methods and forms could be implemented using software written in a variety of languages including any combination of C, C++, C#, java script, HTML, dynamic HTML, HTML controls, ActiveX controls, Web Form controls, java controls, etc. Some or all of the software could be stored on a computer readable medium such as the non-volatile memory 162 or the volatile memory 158 of the computing device 150. In general, computer readable media includes computer storage media and communication media. Computer storage media includes volatile and nonvolatile, removable and non-removable media implemented in any method or technology for storage of information such as computer readable instructions, data structures, program modules or other data. Computer readable media includes, but is not limited to, RAM, ROM, EPROM, EEPROM, flash memory or other memory technology, CD-ROM, DVD or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer readable media.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A user interface method comprising:
displaying an electronic form to a user, the electronic form to allow the user to gather information;
detecting an event associated with the electronic form;
determining a context based on the event associated with the electronic form;
retrieving information relevant to the context; and
modifying the displayed electronic form to allow the electronic form to display to the user the information relevant to the context.

2. A method according to claim 1, wherein the electronic form comprises a form associated with at least one of a line-of-business software application, a front-office software application, and a back-office software application.

3. A method according to claim 2, wherein the electronic form comprises a customer relationship management form.

4. A method according to claim 3, wherein the electronic form comprises at least one of a scheduling form, a case form to assist with tracking and resolving a customer service issue, a form associated with recording information related to an account, a form associated with recording information related to a contact, a form to specify a task, a form to send one or more facsimiles, a form to make a phone call, a form to send one or more E-mails, a form to send one or more letters, a form to make an appointment, a form associated with an advertising campaign, a form associated with sales, a form associated with tracking potential sales, a form associated with sales of products, a form associated with sales quotes, a form associated with orders, a form associated with invoices, a form associated with providing services, a form associated with service contracts, a form associated with contract lines.

5. A method according to claim 1, wherein displaying the electronic form comprises displaying the electronic form using a web browser.

6. A method according to claim 1, wherein detecting the event comprises detecting an activity of the user.

7. A method according to claim 6, wherein detecting the activity of the user comprises detecting an on-focus event associated with the electronic form.

8. A method according to claim 1, wherein determining the context comprises selecting one of a plurality of possible contexts based on the detected event.

9. A method according to claim 1, wherein determining the context comprises determining the context further based on information entered into the form by the user.

10. A method according to claim 1, wherein retrieving information relevant to the context comprises retrieving information based on information entered into the form by the user.

11. A method according to claim 1, wherein retrieving information relevant to the context comprises retrieving information from one or more of a file, a database, and a separate computer system via a network.

12. A method according to claim 1, wherein retrieving information relevant to the context comprises retrieving information according to a set of rules.

13. A method according to claim 1, wherein modifying the displayed electronic form comprises immediately displaying at least some of the information relevant to the context in the portion.

14. A method according to claim 1, further displaying at least some of the information relevant to the context in the portion in response to a user selection associated with the portion.

15. A method according to claim 1, wherein the electronic form comprises a user input portion and an informational portion, and wherein the electronic form includes controls to allow the display of information received from a server in the informational portion;
wherein modifying the displayed electronic form comprises using the controls of the electronic form to display the retrieved information relevant to the context in the informational portion.

16. A user interface method, comprising:
receiving a request for an electronic form via a network, the electronic form to allow a user to gather information;
transmitting the electronic form via the network, the electronic form including controls to allow a portion of the electronic form to display information received from a server;
receiving data indicative of a context via the network, the context associated with the electronic form;
retrieving information relevant to the context; and
transmitting the information relevant to the context via the network, the information to be displayed in the electronic form.

17. A method according to claim 16, wherein receiving data indicative of the context comprises receiving data indicative of an event associated with the electronic form.

18. A method according to claim 17, wherein receiving data indicative of the context comprises receiving data indicative of a user activity;
the method further comprising determining the context based on the received data indicative of the user activity.

19. A method according to claim 16, wherein the electronic form comprises a form associated with at least one of a line-of-business software application, a front-office software application, and a back-office software application.

20. A method according to claim 16, wherein the electronic form comprises a form configured to be displayed by a web browser.

21. A method according to claim 16, wherein transmitting the information relevant to the context via the network comprises transmitting the information relevant to the context via at least one of a local area network, a wide area network, a wireless network, the Internet, and an extranet.

22. A computer readable medium having computer execuitable instructions for performing a user interface method, the computer readable medium comprising:
computer executable instructions for receiving a request for an electronic form via a network, the electronic form to allow a user to gather information;
computer executable instructions for transmitting the electronic form via the network, the electronic form including controls to allow a portion of the electronic form to display information received from a server;
computer executable instructions for receiving data indicative of a context via the network, the context based on an event associated with the electronic form;
computer executable instructions for retrieving information relevant to the context from a database; and
computer executable instructions for transmitting the information relevant to the context via the network, the information to be displayed in the electronic form.
